(19) United States
(12) Patent Application Publication
(10) Pub. No.: US 2008/0163719 A1
(43) Pub. Date: Jul. 10, 2008

(54) Handlebar palm support

(76) Inventor: James W. O'Reilly, Tallahassee, FL (US)

Correspondence Address: John Wiley Horton;Pennington, Moore, Wilkinson, Bell & Dunbar, P.A., 2nd Floor, 215 S. Monroe St., Tallahassee, FL, 32301, US

(21) Appl. No.: 11/650,090

(22) Filed: Jan. 5, 2007

(51) Int. Cl. B62K 21/12

(52) U.S. Cl. 74/551.8

(57) ABSTRACT

A palm support for a drop style handlebar. The palm support includes an attachment means for attaching the palm support to the handlebar frame along the forward portion of the frame between the forward bend and the hood. The palm support also includes a support member which projects outwardly away from the frame and supports the outer portion of the rider's palm (the portion of the palm distal to the thumb and proximal to the fifth metacarpal bone) when the rider grips the hood.

### BACKGROUND OF THE INVENTION

1. Field of the Invention

This invention relates to the field of bicycles. More specifically, the invention comprises a palm support for a “drop” style bicycle handlebar.

2. Description of the Related Art.

Most touring and racing bicycles utilize “drop” style handlebars. An example of a drop style handlebar is illustrated in FIG. 1. The frame of handlebar 1 principally comprises a single piece of aluminum or carbon tubing bent as shown. Handlebar 1 has a straight middle portion 31 that is horizontal with respect to the ground. Middle portion 31 is approximately as wide as the rider's shoulders. Handlebar 1 is attached to the bicycle at the center of middle portion 31 by a clamping device referred to as the “stem.” Bend 30 lies on each end of middle portion 31. Bend 30 is a 90 degree bend that directs the tubing in the forward direction (relative to the rider). The tubing extends forward for a short distance forming forward portion 32. The tubing then bends downward (toward the ground) and then backward forming a crescent moon shape with concavity facing rearwards (toward the rider). Handlebar 1 terminates with a short, straight section. The portion of the handlebar between bend 30 and the end of the tubing is referred to as the “drop.”

Handlebar 1 is constructed in this manner to allow the rider to use multiple hand positions when steering the bike. Handlebar 1 also provides a location for mounting a hand brake or a shift lever. As illustrated in FIG. 1, brake/shift lever assembly 2 is typically attached to handlebar 1 at the most forward point of forward portion 32 at the point where the tubing begins its downward bend. Brake/shift lever assembly 2 includes hood 22 which provides a gripping platform around which the user may wrap his or her fingers and thumb. Brake/shift lever 23 extends away from hood 22 and is used to actuate the brake or shift gears.

There are several different gripping positions which are commonly used by riders. In one gripping position, the rider places each hand on middle portion 31 on either side of the stem. In a second gripping position, the rider grasps each drop 3 with a hand. This position allows the rider to assume a smaller profile and reduce wind resistance. In the last main gripping position, the rider grasps each hood 22 with a hand. This hand position is often referred to as “on the hoods.” The “on the hoods” position is generally used when riding the bicycle over flat terrain and when climbing hills. Thus, the majority of the time is spent steering the bicycle from the hoods.

When riding on the hoods, the rider rests the portion of rider's palm between the thumb and index finger on the top of the hood. The rider then wraps the thumb around the inside portion of the hood and the fingers around the outside portion of the hood. The inside carpus area of the wrist is then supported by the handlebar tubing. The outer portions of the palm (portions of the palm distal to the thumb, including the metacarpus area of the fingers and the outer portion of the wrist) are left unsupported and drape off the outer sides of the hood. Thus, the thumb acts as a hook which keeps the hands from sliding off the hoods. Grip is maintained by squeezing the thumb and fingers together.

Many riders experience a substantial amount of pain and discomfort when riding “on the hoods.” Substantial pressure is applied to the inside area of the hand contacting the hoods while riding, since this area of the hand supports the forward and downward leaning weight of the rider's upper torso. This asymmetric pressure on the inside of the palm and the lack of support on the outside of the palm causes the hand to rotate off the sides of the hood. The rider counteracts this rotation by constantly squeezing and gripping the hood with the thumb and fingers. Additional pressure is also applied to the inside palm area during braking when the forward momentum of the rider is transmitted to the handlebars. This pressure on the inside palm area compresses nerves which control hand muscles and convey sensory data from the hand. Prolonged compression of these nerves results in and numbness, pain, weakness in grip, and a loss of hand function. This loss of hand function reduces the rider's ability to steer, brake, and shift the bicycle.

Although several inventors have developed different types of ergonomic handles and padding designed to make gripping a handlebar more comfortable, these devices do not provide the needed outside support for the hand while riding on the hoods. It is therefore desirable to provide a palm support which addresses these shortcomings of the prior art.

### BRIEF SUMMARY OF THE INVENTION

The present invention is a palm support for a drop style handlebar. The palm support includes an attachment means for attaching the palm support to the handlebar frame along the forward portion of the frame between the forward bend and the hood. The palm support also includes a support member which projects outwardly away from the frame and supports the outer portion of the rider's palm (the portion of the palm distal to the thumb and proximal to the fifth metacarpal bone) when the rider grips the hood.

The palm support reduces the pressure on the interior portion of the rider's palm when riding on the hoods. The palm support also counteracts the asymmetric pressure on the inside of the palm which has the tendency to cause the hands to rotate off the hood. Accordingly, the palm support provides a more comfortable gripping position and reduces the numbness and pain rider's experience while riding on the hoods. The palm support also provides a new gripping position that may be utilized when steering the bicycle.

### BRIEF DESCRIPTION OF THE SEVERAL VIEWS OF THE DRAWINGS

FIG. 1 is a perspective view, showing a prior art drop style handlebar.

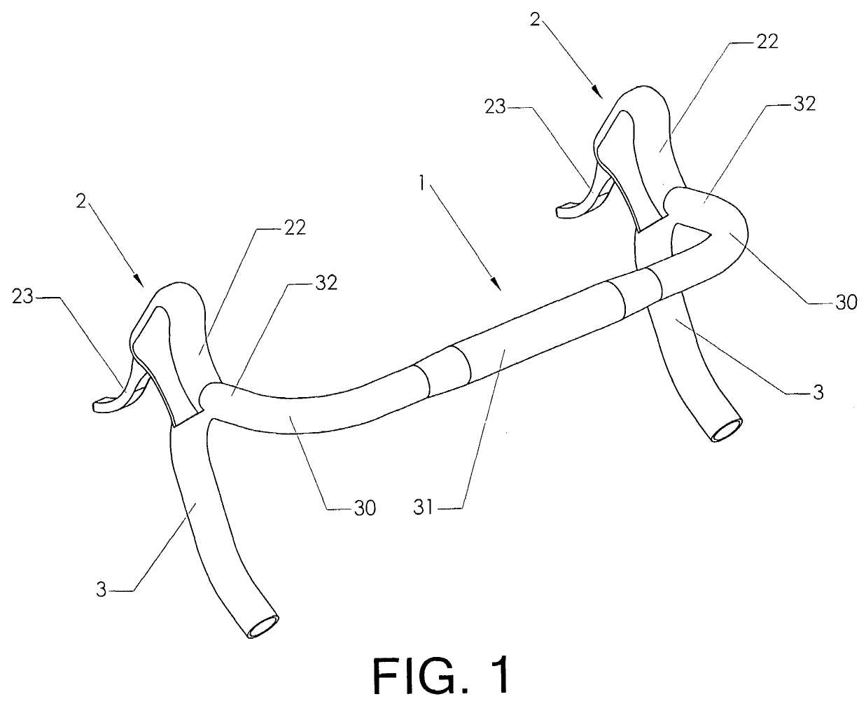

FIG. 2 is a perspective view, showing a drop style handlebar with palm supports.

FIG. 3 is an exploded view, showing a palm support.

FIG. 4 is a section view, showing a support member.

FIG. 5 is an end view, showing a support member.

FIG. 6 is a back view, showing a palm Support attached to a handlebar.

FIG. 7 is a section view along the II-II plane of FIG. 6, showing the palm support attached to a handlebar.

FIG. 8 is a top view, showing a palm support attached to a handlebar.

FIG. 9 is a section view along the I-I plane of FIG. 8, showing a palm support attached to a handlebar.

FIG. 10 is a top view, illustrating how the palm support provides support to the exterior portion of a rider's palm when gripping the hood.

FIG. 11 is an end view, illustrating how the palm support provides support to the exterior portion of a rider's palm when gripping the hood.

FIG. 12 is a top view, illustrating how the palm support provides support to the exterior portion of a rider's palm when gripping the hood.

FIG. 13 is a top view, illustrating how the palm support may be utilized for a new gripping position.

FIG. 14 is an end view, illustrating how the palm support may be utilized for a new gripping position.

FIG. 15 is a top view, illustrating how the palm support may be utilized for a new gripping position.

FIG. 16 is a perspective view, showing an alternate embodiment of the present invention.

FIG. 17 is an exploded view, showing an alternate embodiment of the present invention.

### REFERENCE NUMERALS IN THE DRAWINGS

| | | | |
|---|---|---|---|
| 1 | handlebar | 2 | brake/shift lever assembly |
| 3 | drop | 4 | support member |
| 5 | band | 6 | bolt |
| 7 | cover | 8 | top wall |
| 9 | bottom wall | 10 | forward wall |
| 11 | rearward wall | 12 | middle wall |
| 13 | transverse wall | 14 | bore |
| 15 | surface relief | 16 | bolt receiver |
| 17 | contact point | 18 | contact point |
| 19 | protrusion | 21 | hand |
| 22 | hood | 23 | brake/shift lever |
| 24 | palm support | 25 | relief |
| 26 | relief | 27 | palm support |
| 30 | bend | 31 | middle portion |
| 32 | forward portion | | |

### DETAILED DESCRIPTION OF THE INVENTION

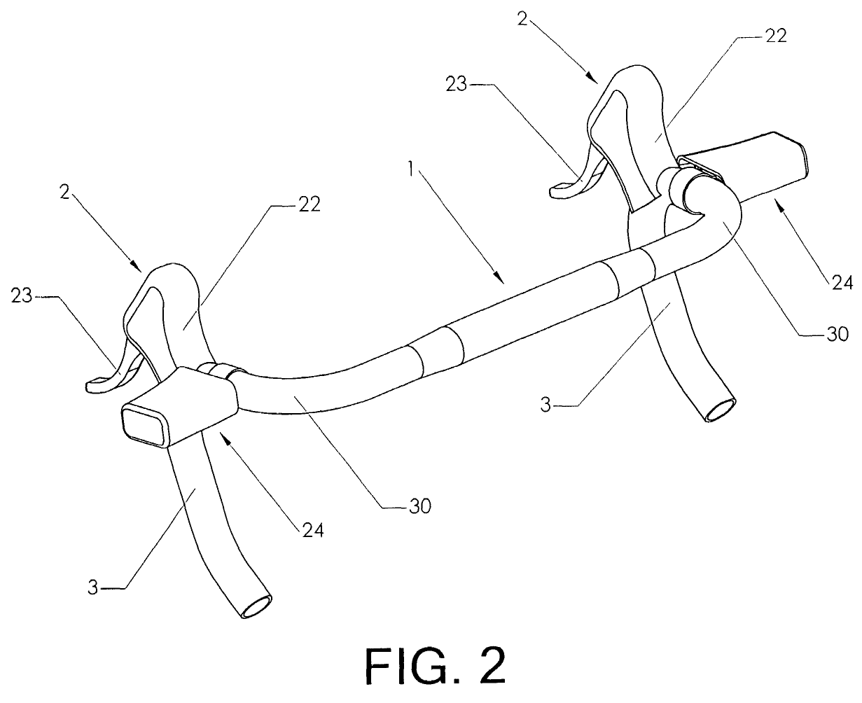

As illustrated in FIG. 2, palm supports 24 are attached to the frame of handlebar 1 between bend 30 and hood 22. When placed in this location, palm supports 24 provide support to the outer portion of the rider's palms (the portion of the palm distal to the thumb and proximal to the fifth metacarpal bone) when “riding on the hoods.”

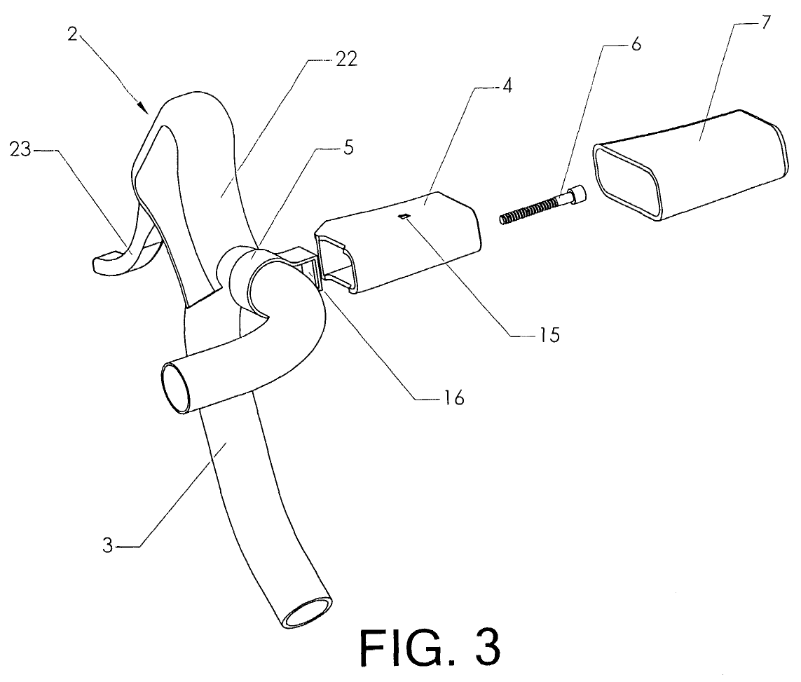

Turning now to FIG. 3, an attachment means for attaching the palm support to the frame is illustrated. The palm support includes a band clamp, a support member, a bolt, and a cover. The band clamp includes band 5 which is adapted to wrap around the frame of the handlebar and bolt receiver 1 6 which has female threading. Support member 4 mates with the surface of the frame on one end and the other end of support member 4 extends outwardly away from the frame. Bolt 6 has a threaded shank which extends axially through a bore in support member 4 and engages the female threading of bolt receiver 16. When bolt 6 engages the female threading and is tightened, the frame is clamped between band 5 and support member 4. Cover 7 is preferably made of rubber or plastic for improved gripability and comfort.

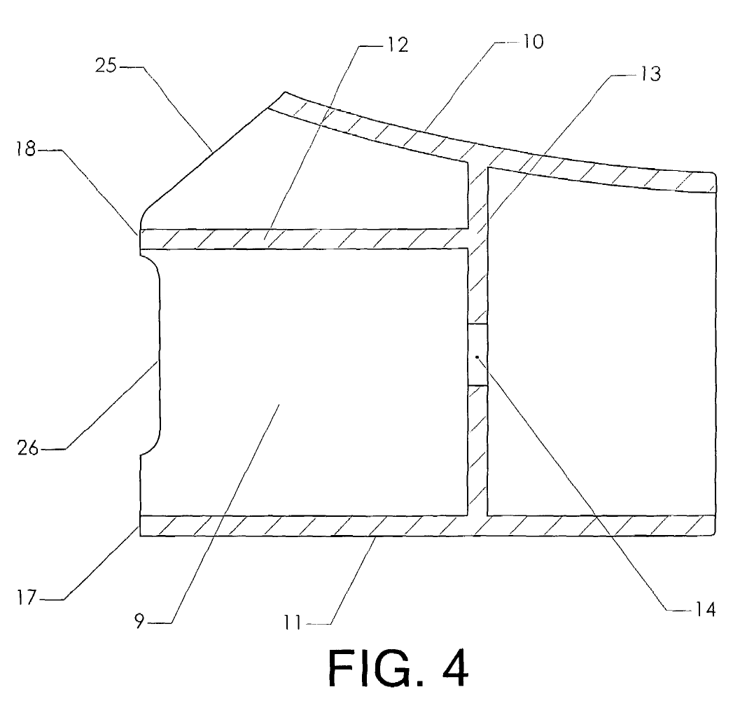

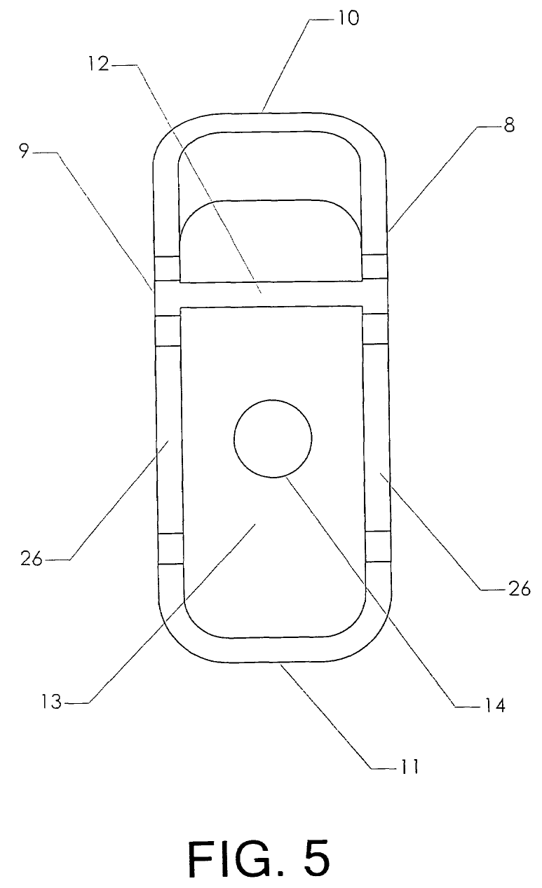

Support member 4 is illustrated in greater detail in FIGS. 4 and 5. FIG. 4 is a section view of support member 4. In the preferred embodiment, support member 4 has rearward wall 11, forward wall 10, top wall 8, and bottom wall 9 which extend from one end of support member 4 to the other. Transverse wall 13 extends across the interior of support member 4 between rearward wall 11, forward wall 10, top wall 8, and bottom wall 9. Middle wall 12 extends from transverse wall 13 toward the end of support member 4 that mates with the handlebar frame. Bore 14 passes axially through transverse wall 13 and receives the shank of bolt 6. Reliefs 26 are provided in top wall 8 and bottom wall 9 and receive band 5 when the support member and band clamp are attached to the frame. When clamped to the frame, contact points 17 and 18 mate with the frame. Relief 25 is provided along forward wall 10 to allow for overlap with a portion of hood 22. This overlap allows the components to be placed more closely together and provides a smooth union between the two components.

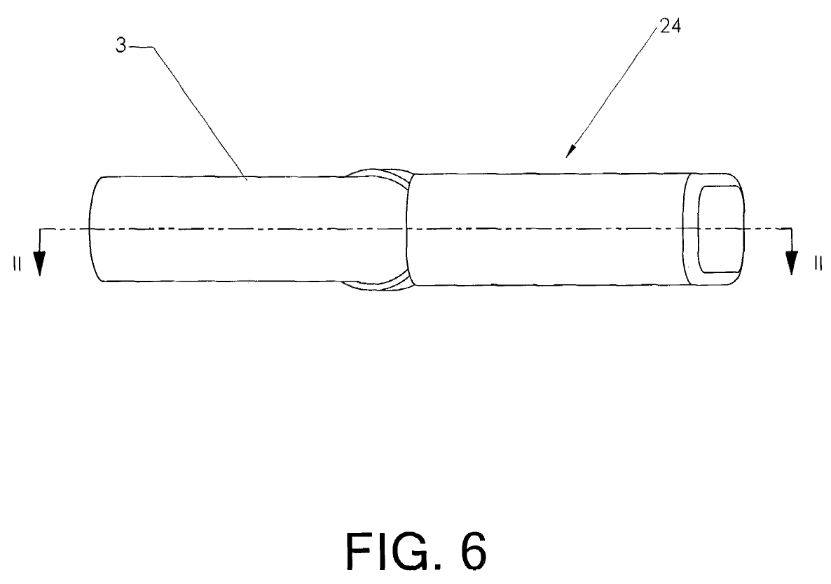

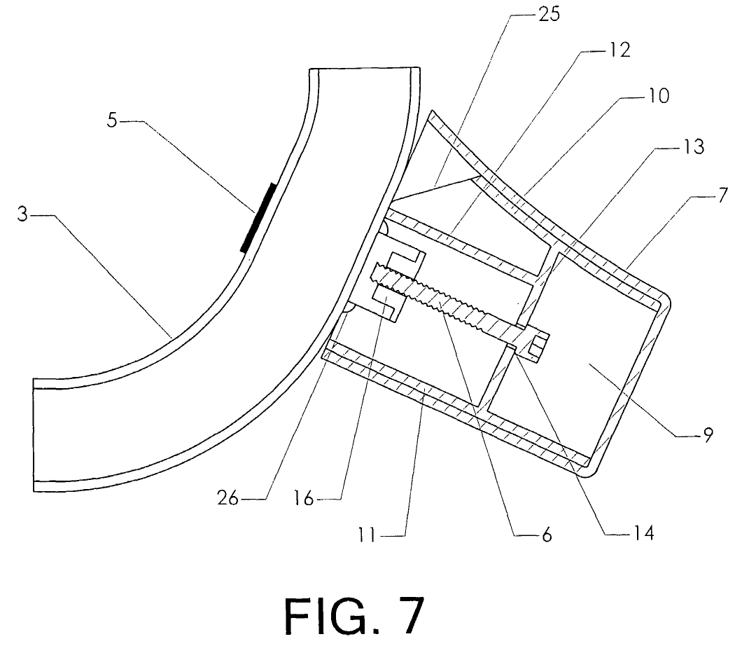

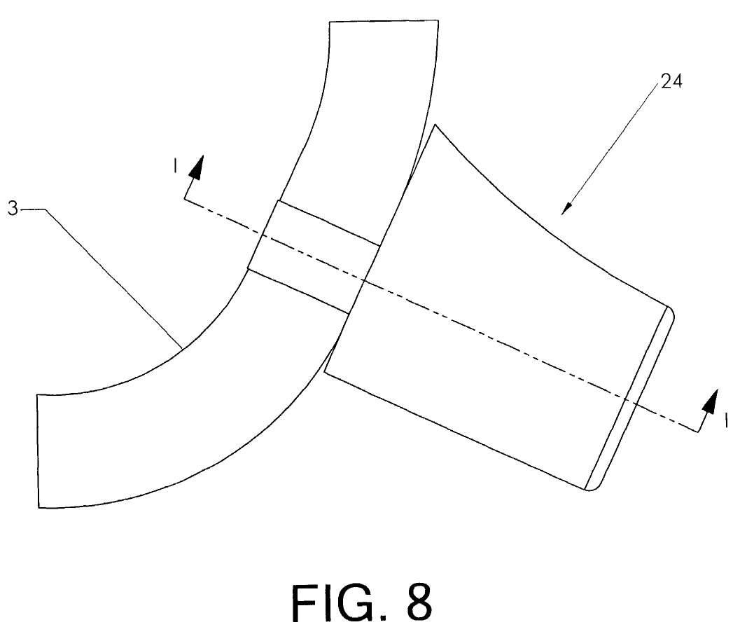

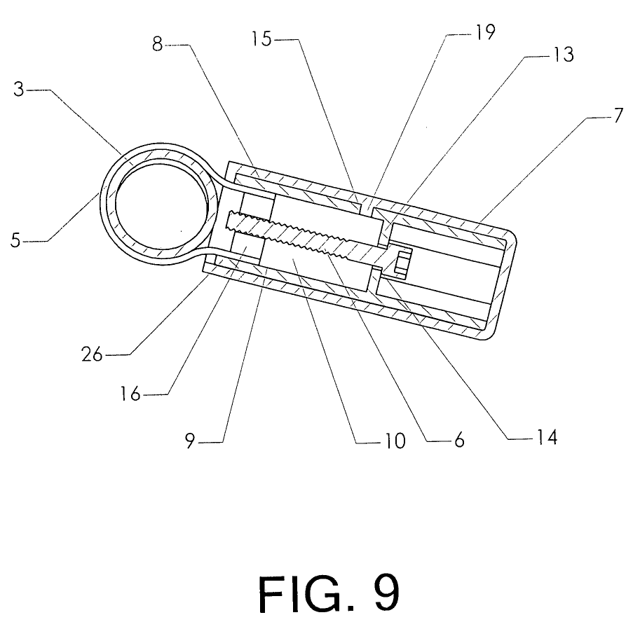

FIG. 7 is a section view along the II-II plane of FIG. 6, showing the palm support attached to the handlebar frame. FIG. 9 is a section view along the I-I plane of FIG. 8, showing the palm support attached to the handlebar frame. As illustrated in FIGS. 7 and 9, bolt 6 secures the palm Support to band 5. When bolt 6 is tightened, band 5 and the support member compress around the frame. Referring to FIG. 9, the reader will note how protrusion 19 on cover 7 engages surface relief 15 (shown more clearly in FIG. 3) on top wall 8 of the support member. This keeps cover 7 from sliding off of the support member. Cover 7 is made of some pliable material (such as rubber or polymer).

The reader will note that the clamping type of attachment mechanism allows the rider to vary the “lean” of the palm Support as desired. For example, the rider may loosen bolt 6 and tilt forward wall 10 downward relative to rearward wall 11. Support member 4 may be rotated along the axis of bolt 6 until relief 26 contacts band 5. This allows the rider to develop a customized lean that suits the rider's preferences.

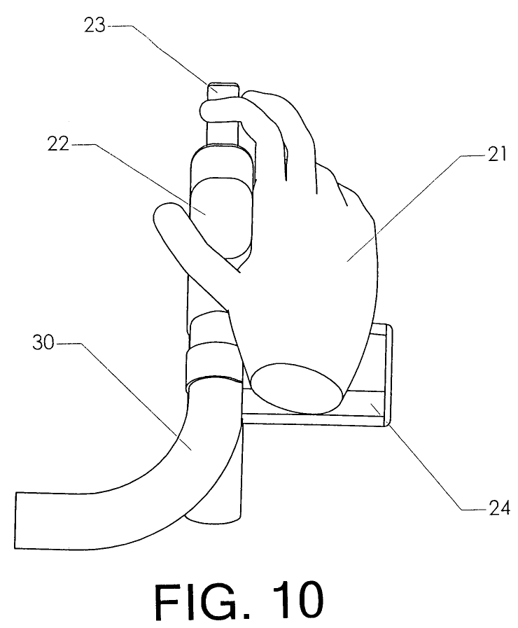

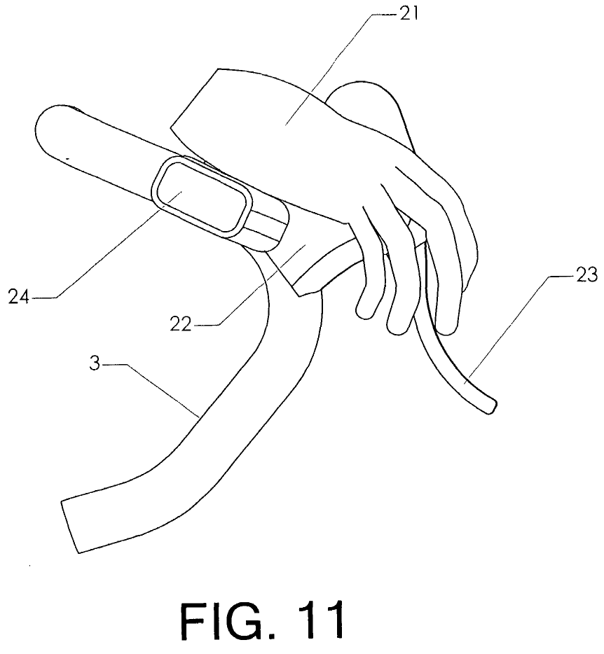

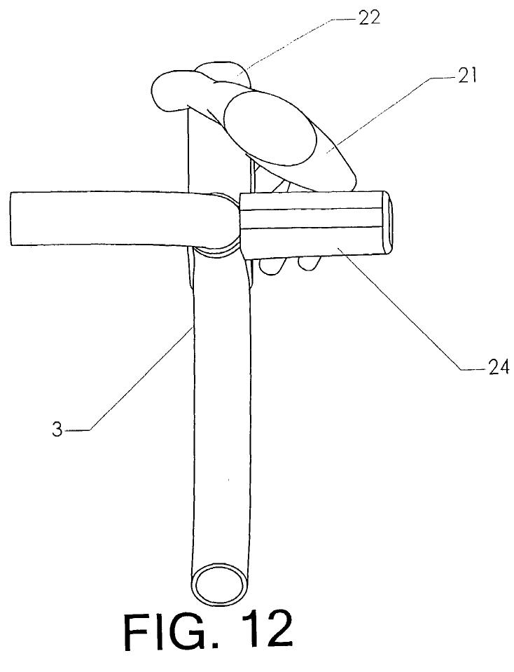

FIGS. 10, 11, and 12 show how palm support 24 supports the outside portion of the rider's palm when riding on the hoods. The rider places the thumb of hand 21 on the interior portion of hood 22 as normal when riding on the hood. The inner portion of the palm (proximal the first metacarpal bone) rests on top of the hood, and the carpus area of the hand rests on palm Support 24. Palm support 24 extends far enough away from the frame and hood 22 to support the outer portion of the rider's palm (proximal the fifth metacarpal bone). This riding position is more comfortable and allows the rider to easily actuate brake/shift lever 23 with the index and middle fingers.

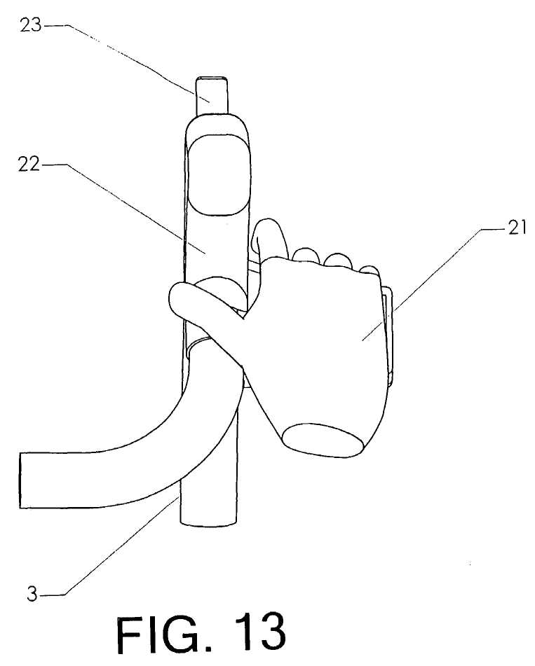

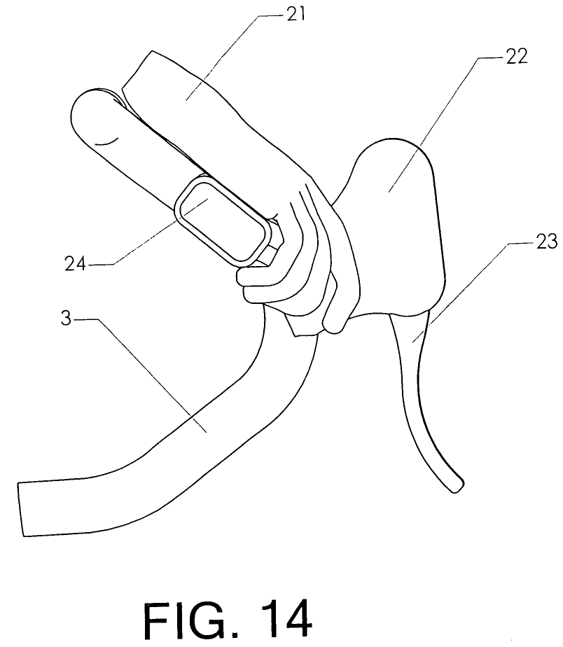

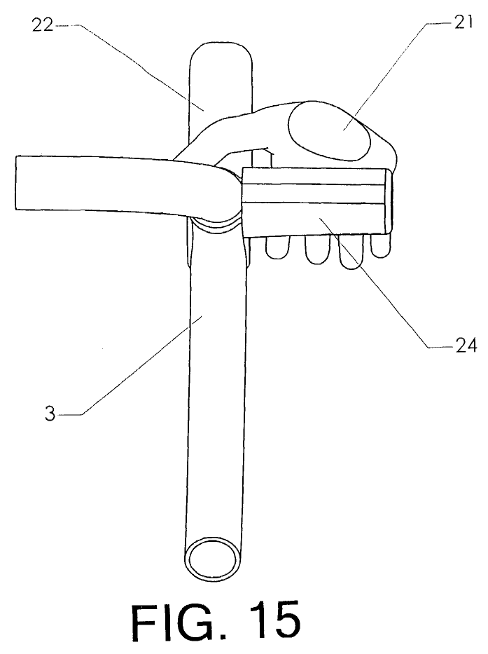

FIGS. 13, 14, and 15 show how palm support 25 may also be used to create an entirely new gripping position. When steering the bicycle in this position, the rider places the thumb of hand 21 around the inside portion of the frame and grasps palm support 24 with the fingers. Although the rider cannot actuate brake/shift lever 23 from this position, the rider only needs to shift hand 21 up hood 22 to bring brake/shift lever 23 into reach.

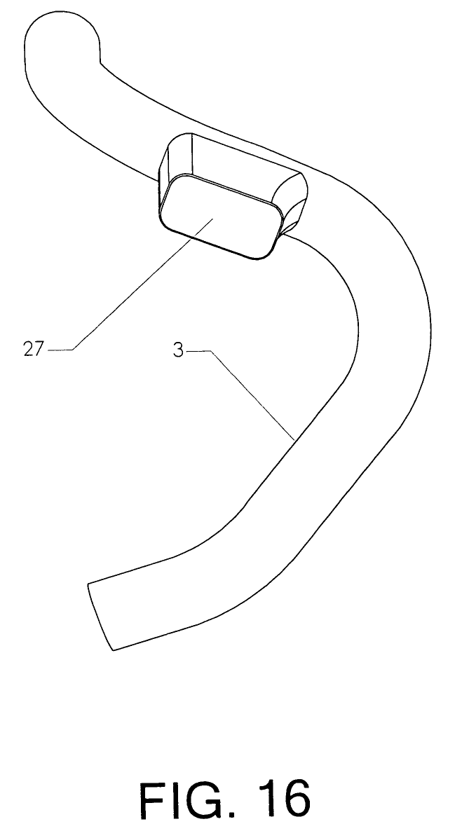

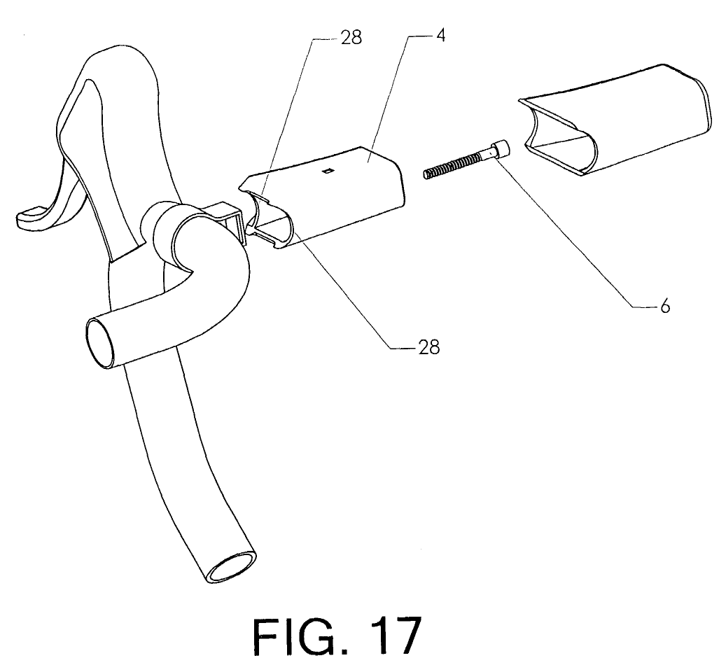

The preceding description contains significant detail regarding the novel aspects of the present invention. It should not be construed, however, as limiting the scope of the invention but rather as providing illustrations of the preferred embodiments of the invention. For example, as illustrated in FIG. 16, palm support 27 may be integrated with the frame (it may be molded as part of the handlebar or welded to it). Also, as illustrated in FIG. 17, support member 4 may be “keyed” to fit a specific section of the frame with reliefs 28. This feature allows the forward lean of the palm support to be preset so that no rotation of support member 4 relative to the axis of bolt 6 is possible. Such variations would not alter the function of the invention. Thus, the scope of the invention should be fixed by the following claims, rather than by the examples given.

Having described my invention, I claim:

1. A palm support adapted for supporting a hand of a rider when said rider is gripping a hood on a handlebar with said hand, said hand having a thumb and a palm, said palm divided into an inner portion proximal said thumb and the first metacarpal bone and an outer portion distal said thumb and proximal the fifth metacarpal bone, said handlebar configured to attach to a stem of a bicycle, said handlebar having (i) a frame, said frame having a middle portion configured to attach to said stem, said middle portion having a first end and a second, a first forward bend proximal said first end of said middle portion, a first forward portion adjacent to said first forward bend, said first forward portion having a first end and a second end, said first end of said first forward portion proximal said first forward bend, and a first downward bend proximal said second end of said first forward portion; and (ii) a first hood, said first hood attached to said frame proximal said first downward bend, said palm support comprising:
a. a support member, said support member attached to said frame along said first forward portion between said first forward bend and said first downward bend, said support member extending outward away from said stem, said support member configured to support said outer portion of said palm of said rider when said rider grips said first hood with said hand and places said inner portion of said palm on said first hood and said outer portion of said palm on said palm support.

2. The palm support of claim 1, further comprising:
a. an attachment means configured to attach said support member to said frame along said first forward portion of said frame between said first forward bend and said hood; and
b. wherein said support member has a first end proximal said frame when said first support member is attached to said frame and a second end extending outward and away from said frame.

3. The palm support of claim 1, further comprising a band clamp configured to attach said support member to said frame, said band clamp having
a. a band adapted to wrap around said frame of said handlebar; and
b. a threaded bolt receiver attached to said band, said threaded bolt receiver having female threading.

4. The palm support of claim 2, said attachment means further comprising a band clamp, said band clamp having
a. a band adapted to wrap around said frame of said handlebar; and
b. a threaded bolt receiver attached to said band, said threaded bolt receiver having female threading.

5. The palm support of claim 2, said support member further comprising a bore passing axially through said support member between said first end and said second end.

6. The palm Support of claim 4, said support member further comprising a bore passing axially through said support member between said first end and said second end.

7. The palm support of claim 6, said attachment means further comprising a bolt, said bolt having a threaded shank configured to pass through said bore of said support member and engage said female threading of said threaded bolt receiver so that when said bolt engages said female threading, said frame is clamped between said band clamp and said first end of said support member.

8. A palm support for supporting a hand of a rider when said rider is gripping a hood on a handlebar with said hand; said hand having a thumb and a palm, said palm divided into an inner portion proximal said thumb and the first metacarpal bone and an outer portion distal said thumb and proximal the fifth metacarpal bone; said handlebar including a frame and a first hood; said frame having a middle portion having a first end and a second, a first forward bend proximal said first end of said middle portion, a first forward portion adjacent to said first forward bend, said first forward portion having a first end and a second end, said first end of said first forward portion proximal said first forward bend, and a first downward bend proximal said second end of said first forward portion; said first hood attached to said frame proximal said first downward bend; said palm support comprising:
a. an attachment means configured to attach said palm support to said frame along said first forward portion of said frame between said first forward bend and said hood;
b. a support member having a first end proximal said frame when said palm support is attached to said frame and a second end extending outward and away from said frame; and
c. wherein said support member is configured to support said outer portion of said palm of said rider when said rider grips said first hood with said hand and places said inner portion of said palm on said first hood and said outer potion of said palm on said palm support.

9. The palm support of claim 8, said palm support further comprising a band clamp configured to attach said first palm support to said frame, said band clamp having
a. a band adapted to wrap around said frame of said handlebar; and
b. a threaded bolt receiver attached to said band, said threaded bolt receiver having female threading.

10. The palm support of claim 8, said support member further comprising a bore passing axially through said support member between said first end and said second end.

11. The palm Support of claim 9, said support member further comprising a bore passing axially through said support member between said first end and said second end.

12. The palm support of claim 11, said attachment means further comprising a bolt, said bolt having a threaded shank configured to pass through said bore of said support member and engage said female threading of said threaded bolt receiver so that when said bolt engages said female threading, said frame is clamped between said band clamp and said first end of said support member.

13. A palm support for supporting a hand of a rider when said rider is gripping a hood on a handlebar with said hand; said hand having a thumb and a palm, said palm divided into an inner portion proximal said thumb and the first metacarpal bone and an outer portion distal said thumb and proximal the fifth metacarpal bone; said handlebar including a frame and a first hood; said frame having a middle portion having a first end and a second, a first forward bend proximal said first end of said middle portion, a first forward portion adjacent to said first forward bend, said first forward portion having a first end and a second end, said first end of said first forward portion proximal said first forward bend, and a first downward bend proximal said second end of said first forward portion; said first hood attached to said frame proximal said first downward bend; said palm support comprising:
a. a band clamp having
i. a band adapted to wrap around said frame of said handlebar;
ii. a threaded bolt receiver attached to said band, said threaded bolt receiver having female threading;
b. a support member having
i. a first end adapted to mate with the surface of said frame;
ii. a second end extending away from said frame when said first end of said support member mates with said surface of said frame;
iii. a bore passing axially through said support member between said first end and said second end;
c. a bolt, said bolt having a threaded shank configured to pass through said bore of said support member and engage said female threading of said threaded bolt receiver so that when said bolt engages said female threading, said frame is clamped between said band clamp and said first end of said support member; and
d. wherein said palm support is configured to attach to said handlebar on said first forward portion proximal said first hood so that said support member supports said outer portion of said palm of said rider when said rider grips said first hood with said hand and places said inner portion of said palm on said first hood and said outer portion of said palm on said palm support.
